(19) United States
(12) Patent Application Publication
(10) Pub. No.: US 2026/0145461 A1
(43) Pub. Date: May 28, 2026

(54) WHEEL ASSEMBLY STRUCTURE OF VEHICLE

(71) Applicants: HYUNDAI MOTOR COMPANY, SEOUL (KR); KIA CORPORATION, SEOUL (KR)

(72) Inventor: Jonghoon Lee, Hwaseong-si (KR)

(73) Assignees: HYUNDAI MOTOR COMPANY, SEOUL (KR); KIA CORPORATION, SEOUL (KR)

(21) Appl. No.: 19/328,566

(22) Filed: Sep. 15, 2025

(30) Foreign Application Priority Data
Nov. 26, 2024 (KR) 10-2024-0170784

(51) Int. Cl. B60B 27/00; B60G 13/00; B60K 7/00; B62D 7/18; H02K 1/2706

(52) U.S. Cl. CPC B60B 27/0015; B60G 13/005; B60K 7/0007; B62D 7/18; H02K 1/2706

(57) ABSTRACT

A wheel assembly structure of a vehicle may include a wheel on which a tire of a vehicle is mounted, a rotor housing connected to the wheel to rotate with the wheel, a stator housing fixed to the vehicle, and configured to rotate the rotor housing by application of current, a wheel hub extending at a central portion of the wheel toward the vehicle inner side, a knuckle having a first end rotatably connected to the wheel hub, and a second end extending toward an inner side of the vehicle, a shock absorber connected to a second end of the knuckle, and configured to alleviate shock between the stator housing and the wheel, and an assembly bracket connected to the stator housing, coupled to an upper end and a lower end of the shock absorber, protruding toward the inner side of the vehicle.

### CROSS REFERENCE TO RELATED APPLICATIONS

This application claims priority to and the benefit of Korean Patent Application No. 10-2024-0170784 filed with the Korean Intellectual Property Office on Nov. 26, 2024, the entire contents of which is incorporated herein by reference.

### BACKGROUND

### (a) Field

The present disclosure relates to a wheel assembly structure of a vehicle, and more particularly, the present disclosure relates to a wheel assembly structure of the vehicle provided with an in-wheel motor.

### (b) Description of the Related Art

An in-wheel drive system is mounted on wheels of each vehicle wheel, and in vehicles that run on electric power such as hybrid vehicles, fuel cell vehicles, and electric vehicles, is a system that generates and drives power for each vehicle wheel by installing a small individual motor on each vehicle wheel instead of using a large single motor.

The in-wheel drive system has the advantage of providing individual motors (hereinafter referred to as an in-wheel motor) for each wheel to simplify a drive system and increase an interior space compared to a vehicle equipped with a large drive motor, and being able to directly control the rotation of the vehicle wheels to omit a complex power transmission device such as a differential device.

In this way, power train elements may be omitted, exhibiting high efficiency and high performance. That is, by directly installing the in-wheel motor on the wheels of each vehicle wheel, it is possible to reduce power waste and secure sufficient driving power, and by maximizing the distribution of power to each in-wheel motor during driving and the recovery of braking energy due to regenerative braking when braking, it is possible to improve fuel efficiency.

However, in the in-wheel drive system, the in-wheel motor is integrated with the wheels of the vehicle wheel, so an unsprung mass of the vehicle increases, vibration and noise (NVH) of the vehicle increase, and there is a risk of damage to the in-wheel motor due to shock on a lower portion of the vehicle. In addition, there is a problem of configuring a wheel assembly structure to ensure durability of the in-wheel motor and durability due to movement of a high-voltage cable when the wheels move.

Such an in-wheel drive system is equipped with a shock absorber between the wheel and the stator housing to alleviate the shock between the stator housing and the wheel. In this structure, when a buffer member is arranged around the central portion of the rotor housing and a wheel hub is arranged around the outer circumference of the buffer member, the outer diameter of the wheel hub should be increased, and accordingly, the bumping stroke is limited in length, which also limits shock absorption.

In addition, when a buffer member is interposed between the upper surface of the rotor housing and the lower surface of the wheel, the outer diameter of the wheel hub can be reduced, but there is still a limit to increasing the bumping stroke due to the structure in which the protruding portion at the lower end of the central portion of the rotor housing and the outer surface of the wheel hub come into contact.

### SUMMARY

The present disclosure attempts to provide a wheel assembly structure of a vehicle capable of expanding a bumping stroke by decrease the length of a moment arm, and by removing a protrusion portion of a lower end of central portion of rotor housing facing an outer surface of the wheel hub, by connecting a shock absorber support portion (e.g., knuckle) configured to fix a shock absorber to a wheel hub of the vehicle, mounting the shock absorber on the assembly bracket, and directly fixing upper and lower portions of an assembly bracket to the vehicle body.

A wheel assembly structure of a vehicle may include a wheel on which a tire of a vehicle is mounted, a rotor housing connected to the wheel to rotate with the wheel, a stator housing fixed to the vehicle, and configured to rotate the rotor housing by application of current, a wheel hub extending at a central portion of the wheel toward the vehicle inner side, a knuckle having a first end rotatably connected to the wheel hub, and a second end extending toward an inner side of the vehicle, a shock absorber connected to a second end of the knuckle, and configured to alleviate shock between the stator housing and the wheel, and an assembly bracket connected to the stator housing, coupled to an upper end and a lower end of the shock absorber, protruding toward the inner side of the vehicle.

An upper end and a lower end of the assembly bracket may be directly connected to a vehicle connection portion connected to a vehicle body.

The assembly bracket may be connected to a central end portion of the stator housing in the form of surrounding the shock absorber.

The wheel hub and a first end of the knuckle may be rotatably connected by a wheel hub bearing.

A central end portion of the rotor housing may be bent toward the inner side of the vehicle to be connected to a central end portion of the stator housing.

An upper surface of a bent portion of the central end portion of the rotor housing may be connected to and in contact with a lower surface of a central portion of the stator housing.

A rotor bearing may be interposed between the rotor housing and the stator housing so that the rotor housing relative rotates with respect to the stator housing.

The second end of the knuckle may be fixed to a central lower end portion of the shock absorber.

A permanent magnet may be provided on an inner surface of the rotor housing facing a rotation axis of the rotor housing, and a coil may be provided on an outer surface of the stator housing of a location facing the permanent magnet, so that the rotor housing is rotated by an electromagnetic force caused by applying electric power to the coil.

A spring configured to support a lower surface of an upper portion of the assembly bracket, support a load of the stator housing and the vehicle, and alleviate a shock may be provided on a circumference of the shock absorber.

The shock absorber may have an upper end supported by an inner upper end of the assembly bracket by a bump stopper.

A steering motor connected to the assembly bracket and configured to adjust a steering angle of the assembly bracket and the stator housing connected thereto, along a horizontal direction of the vehicle, may be further provided on a lower end of an outer side of a vehicle body connected to the assembly bracket.

A rotor brake disk may be provided on a central axis of the rotor housing facing the inner side of the vehicle.

The wheel assembly structure may further include a buffer device provided between an inner circumference of the wheel and an outer circumference of the rotor housing and configured to alleviate a shock transferred from the tire and the wheel to the rotor housing.

The buffer device may be formed of an air spring.

The buffer device may be formed by connecting a plurality of cross-sections having a hexagonal-shaped hollow.

The tire may be an airless tire that does not require injection of air.

According to an embodiment, in a wheel assembly structure including an in-wheel motor including a stator and a rotor, by being provided with the shock absorber support portion (e.g., knuckle) configured to fix the shock absorber to a wheel hub of a vehicle, and by directly fixing the assembly bracket mounted with the shock absorber to the vehicle body, strength may be improved by dispersing the vertical load transferred from the vehicle lower portion to the in-wheel motor by decreasing the length of a moment arm.

In addition, by removing the protrusion portion of the lower end of the central portion of the rotor housing facing the outer surface of the wheel hub, the outer diameter of the wheel hub may be decreased, and by removing the air injection valve by applying an airless type tire, the bumping stroke may be expanded.

In addition, a buffer device of an air spring type absorbing the load transferred to the motor, and a shock absorber absorbing the load transferred through the bearing of the wheel hub may be separately installed, thereby improving the spatial degree of freedom in the aspect of design.

In addition, according to the present disclosure, by applying to the skateboard platform applied to mobility vehicles, it is possible to contribute to the marketability of the mobility vehicle.

### BRIEF DESCRIPTION OF THE FIGURES

FIG. 1 is a top plan view showing a wheel assembly structure of a vehicle according to an embodiment as viewed from the outer side of the vehicle.

FIG. 2 is a top plan view showing a wheel assembly structure of a vehicle according to an embodiment as viewed from the vehicle inner side.

FIG. 3 is a cross-sectional view taken along line ‘A-A’ of FIG. 2.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

In various exemplary embodiments, the same reference numerals are used for elements having the same configurations and will be representatively described in a first exemplary embodiment, and in other exemplary embodiments, only elements different from those of the first exemplary embodiment will be described.

The drawings are schematic, and are not illustrated in accordance with a scale. Relative dimensions and ratios of portions in the drawings are illustrated to be exaggerated or reduced in size for clarity and convenience, and the dimensions are just examples and are not limiting. In addition, like structures, elements, or components illustrated in two or more drawings use same reference numerals for showing similar features. It will be understood that when an element such as a layer, film, region, or substrate is referred to as being “on” another element, it can be directly on the other element or intervening elements may also be present.

The embodiment of the present disclosure shows an embodiment of the present disclosure in detail. As a result, various modifications of the drawings will be expected. Therefore, the embodiments are not limited to a specific shape of an illustrated region, but, for example, include a change in the shape in accordance with manufacturing.

Hereinafter, a wheel assembly structure of a vehicle according to an exemplary embodiment of the present disclosure will be described in detail with reference to the accompanying drawings.

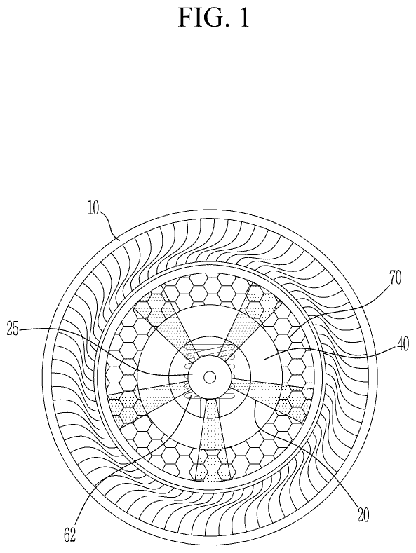

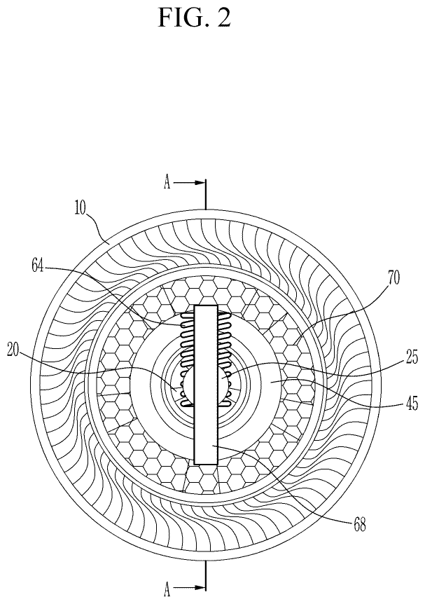

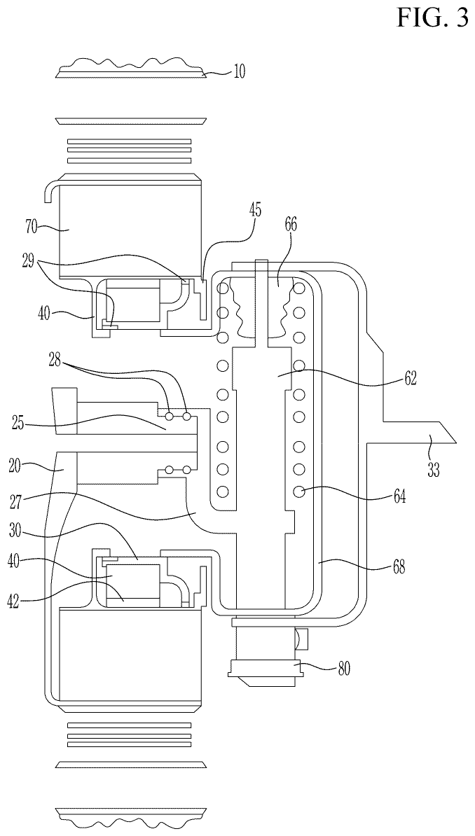

FIG. 1 is a top plan view showing a wheel assembly structure of a vehicle according to an embodiment as viewed from the outer side of the vehicle, FIG. 2 is a top plan view showing a wheel assembly structure of a vehicle according to an embodiment as viewed from the vehicle inner side, and FIG. 3 is a cross-sectional view taken along line ‘A-A’ of FIG. 2.

Referring to FIG. 1 to FIG. 3, a wheel assembly structure of a vehicle according to an embodiment may include a wheel 20 on which a tire 10 of the vehicle is mounted, a rotor housing 40 connected to the wheel 20, a stator housing 30 fixed to the vehicle and configured to rotate the rotor housing 40 by application of current, a wheel hub 25 extending at a central portion of the wheel 20 toward the vehicle inner side, a knuckle 27 rotatably connected to the wheel hub 25, a shock absorber 62 connected to the knuckle 27, and an assembly bracket 68 coupled to an upper end and a lower end of the shock absorber 62 and connected to the stator housing 30.

The stator housing 30 and the rotor housing 40 together may constitute an in-wheel motor.

The in-wheel motors 30 and 40 may be an electric vehicle drive system that drives wheels by directly mounting an electric motor on each wheel. Unlike a drive method using a traditional internal combustion engine and a transmission, efficient energy transfer is possible because the wheels and motors are directly connected.

The wheel 20 is primarily made of metal and rotates about a central axis. The wheel 20 serves to support the tire 10, reduces shock received from the road, and supports a weight of the vehicle.

The tire 10 surrounds an exterior of the wheel 20 and is primarily made of rubber and steel wire. The tire 10 may control a direction and speed of the vehicle by using friction with a road surface. The tire 10 absorbs the shock from the road surface to provide a comfortable driving environment and increases vehicle safety. In an embodiment, the tire 10 may be an airless tire that does not require injection of air (or non-pneumatic tire).

The rotor 40 may be connected to an interior of the wheel 20 and may rotate with the wheel 20. The rotor 40 may be a portion configured to rotate upon receiving electricity in the in-wheel motors 30 and 40. The rotor 40 may serve to transfer the torque to the wheel. A rotation of the rotor 40 is the main means of converting power into mechanical energy.

A stator 30 may be fixed to the vehicle, and rotate the rotor 40 by applying a current. The stator 30 is a fixed part of the in-wheel motors 30 and 40 and may be primarily made of coils 35 or magnets 42. When the electrical energy passes through the stator 30, a magnetic field may be generated, and this magnetic field can rotate the rotor 40.

A rotor bearing 29 may be interposed between the rotor 40 and the stator 30. The bearing allows a shaft to move between the rotor 40 and the stator 30 and is a part that supports the smooth rotation of the internal parts. The rotor may rotate with respect to the stator 30 by the rotor bearing 29.

The knuckle 27 may have a first end rotatably connected to the wheel hub 25, and a second end extending toward an inner side of the vehicle. A wheel hub bearing 28 may be interposed between a first end of the knuckle 27 and an outer circumference of the wheel hub 25. By the wheel hub bearing 28, when the wheel 20 rotates, the wheel hub 25 may rotate with respect to the first end of the knuckle 27. The knuckle 27 may be bent from the first end to the second end by an angle of about 90°.

The shock absorber 62 may be connected to a second end of the knuckle 27, and may alleviate shock between the stator housing 30 and the wheel 20. The second end of the knuckle 27 may be fixed to a central lower end portion of the shock absorber 62.

A spring 64 configured to support a lower surface of an upper portion of the assembly bracket 68, support the load of the stator housing 30 and the vehicle, and alleviate the shock on a circumference of the shock absorber 62.

In addition, the shock absorber 62 may have an upper end supported by an inner upper end of the assembly bracket 68 by a bump stopper 66. A bump stopper 66 may prevent the shock absorber 62 from being in direct contact and colliding with the assembly bracket 68, and may be made of a polymer material having elasticity.

The assembly bracket 68 may be coupled to the upper end and the lower end of the shock absorber 62, and may be connected to the stator housing 30 toward an outer side of the vehicle, and may protrude toward the inner side of the vehicle. The assembly bracket 68 may surrond the shock absorber 62. An upper end and a lower end of the assembly bracket 68 may be directly connected to a vehicle connection portion 33 connected to the vehicle body.

The shock absorber 62 may be coupled to the assembly bracket 68, the assembly bracket 68 may be directly connected to the stator housing 30 and the vehicle connection portion 33, and the second end of the knuckle 27 may be coupled to the central lower end portion of the shock absorber 62, so that the length of the moment arm is decreased to improve load distribution.

Meanwhile, a steering motor 80 may be further provided on a lower end of the outer side of the vehicle body connected to the assembly bracket 68. The steering motor 80 may be connected to the assembly bracket 68 and configured to adjust a steering angle of the assembly bracket 68 and the stator housing 30 connected thereto, along a horizontal direction of the vehicle.

In addition, a rotor brake disk 45 may be provided on a central axis of the rotor housing 40 facing the inner side of the vehicle. A caliper configured to brake the vehicle by applying a frictional force to the rotor housing 40 by being in contact with the rotor brake disk 45 may be provided on the stator housing 30.

In general, in an in-wheel motor, a mechanical braking apparatus may typically exist in the form of disk brakes directly connected to wheels, and the in-wheel motor may perform the function of regenerative braking. The braking apparatus may exist inside the wheel or the in-wheel motor of the vehicle, and may include a caliper and a disk.

The caliper may serve to apply pressure to a brake pad toward the disk, to decrease or stop the rotation of the wheels.

In addition, the disk is a metal plate that rotates with the wheel, and may decrease or stop the rotation of wheels as a brake pad is pressurized toward the disk by the caliper. The braking apparatus included inside the in-wheel motor operates together with the regenerative braking, thereby improving the braking performance and energy efficiency of the vehicle.

The caliper may be an electromechanical brake (EMB) caliper. The EMB caliper is an environment-friendly system that does not use any hydraulic pressure and fully depends on the electrical method, thereby being frequently referred to as a dry type, which may be a complete “Brake-by-Wire” scheme.

Meanwhile, a buffer device 70 configured to alleviate a shock transferred from the tire 10 and the wheel 20 to the rotor housing 40 may be further provided between an inner circumference of the wheel 20 and an outer circumference of the rotor housing 40. The buffer device 70 may comprise an air spring, and may be formed by connecting a plurality of cross-sections having a hexagonal-shaped hollow. The buffer device 70 may be formed of a polymer material having elasticity.

The shock transferred from the road surface to the vehicle may be transferred to the tire 10 and the wheel 20, and may be transferred to the buffer device 70 provided between the inner circumference of the wheel 20 and the outer circumference of the rotor housing 40. The load transferred to the buffer device 70 is transferred to the rotor housing 40, transferred to the assembly bracket 68 connected to the stator housing 30, and then this load is alleviated the shock absorber 62 and transferred to the vehicle body.

Such a duel structured shock alleviation structure may decrease the unsprung mass of the vehicle, and decrease the vibration and noise (NVH) of the vehicle. In addition, the durability the in-wheel motors 30 and 40 and the durability of high voltage cables against motion due to wheel behavior may be ensured.

Meanwhile, a central end portion of the rotor housing 40 may be bent toward the inner side of the vehicle to be connected to a central end portion of the stator housing 30, and an upper surface of a bent portion of the central end portion of the rotor housing 40 may be connected to and in contact with a lower surface of a central portion of the stator housing 30. The rotor bearing 29 may be interposed between the rotor housing 40 and the stator housing 30 so that the rotor housing 40 relative rotates with respect to the stator housing 30.

In this case, the protruding portion in the central end portion of the rotor housing 40 may be removed from between the stator housing 30 and a central side circumference of the wheel 20, and thereby space can be secured. Therefore, the degree of design freedom of the wheel hub 25 and the knuckle 27 may be improved, and the bumping stroke in the vertical direction of the vehicle may be increased.

In addition, due to the buffer device 70, a non-pneumatic tire 10 may be applied, so that an air injection valve may be removed, and a drop center for air pressure maintenance of the tire 10 is not required.

As such, according to an embodiment, in a wheel assembly structure including the in-wheel motor including the stator and the rotor, by being provided with the shock absorber support portion (e.g., knuckle) configured to fix the shock absorber to the wheel hub of the vehicle, and by directly fixing the assembly bracket mounted with the shock absorber to the vehicle body, the strength may be improved by dispersing the vertical load transferred from the vehicle lower portion to the in-wheel motor by decreasing the length of a moment arm.

In addition, by removing the protrusion portion of the lower end of the central portion of the rotor housing facing the outer surface of the wheel hub, the outer diameter of the wheel hub may be decreased, and by removing the air injection valve by applying an airless type tire, the bumping stroke may be expanded.

In addition, a buffer device of an air spring type absorbing the load transferred to the motor, and a shock absorber absorbing the load transferred through the bearing of the wheel hub may be separately installed, thereby improving the spatial degree of freedom in the aspect of design.

In addition, according to the present disclosure, by applying to the skateboard platform applied to mobility vehicles, it is possible to contribute to the marketability of the mobility vehicle.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of appended claims.

1. A wheel assembly structure of a vehicle, comprising:
a wheel;
a tire of a vehicle mounted on the wheel;
a rotor housing connected to the wheel and configured to rotate with the wheel;
a stator housing fixed to the vehicle, and configured to rotate the rotor housing by applying a current;
a wheel hub extending from a central portion of the wheel toward an inner side of the vehicle;
a knuckle having a first end rotatably connected to the wheel hub, and a second end extending toward the inner side of the vehicle;
a shock absorber connected to a second end of the knuckle, and configured to alleviate shock between the stator housing and the wheel; and
an assembly bracket connected to the stator housing, coupled to an upper end and a lower end of the shock absorber, and protruding toward the inner side of the vehicle.

2. The wheel assembly structure of claim 1, wherein an upper end and a lower end of the assembly bracket are each directly connected to a vehicle connection portion connected to a vehicle body.

3. The wheel assembly structure of claim 1, wherein the assembly bracket is connected to a central end portion of the stator housing by surrounding the shock absorber.

4. The wheel assembly structure of claim 1, wherein the wheel hub and a first end of the knuckle are rotatably connected by a wheel hub bearing.

5. The wheel assembly structure of claim 1, wherein a central end portion of the rotor housing is bent toward the inner side of the vehicle, and configured to be connected to a central end portion of the stator housing.

6. The wheel assembly structure of claim 5, wherein an upper surface of a bent portion of the central end portion of the rotor housing is connected to and in contact with a lower surface of a central portion of the stator housing.

7. The wheel assembly structure of claim 1, wherein a rotor bearing is positioned between the rotor housing and the stator housing so that the rotor housing is configured to rotate with respect to the stator housing.

8. The wheel assembly structure of claim 1, wherein the second end of the knuckle is fixed to a central lower end portion of the shock absorber.

9. The wheel assembly structure of claim 1, wherein a permanent magnet is positioned on an inner surface of the rotor housing facing a rotation axis of the rotor housing, and a coil is positioned on an outer surface of the stator housing of a location facing the permanent magnet, wherein the rotor housing is configured to be rotated by an electromagnetic force caused by applying electric power to the coil.

10. The wheel assembly structure of claim 1, wherein a spring is positioned on a circumference of the shock absorber, wherein the spring is configured to support a lower surface of an upper portion of the assembly bracket, to support a load of the stator housing and the vehicle, and to alleviate a shock.

11. The wheel assembly structure of claim 10, wherein the shock absorber has an upper end supported by an inner upper end of the assembly bracket, and wherein a bump stopper is positioned at the upper end of the shock absorber.

12. The wheel assembly structure of claim 1, wherein a steering motor is positioned on a lower end of an outer side of a vehicle body connected to the assembly bracket, the steering motor being configured to adjust a steering angle of the assembly bracket and the stator housing connected thereto along a horizontal direction of the vehicle.

13. The wheel assembly structure of claim 1, wherein a rotor brake disk is positioned on a central axis of the rotor housing facing the inner side of the vehicle.

14. The wheel assembly structure of claim 1, further comprising a buffer device positioned between an inner circumference of the wheel and an outer circumference of the rotor housing, the buffer device being configured to alleviate a shock transferred from the tire and the wheel to the rotor housing.

15. The wheel assembly structure of claim 14, wherein the buffer device comprises an air spring.

16. The wheel assembly structure of claim 15, wherein the buffer device is formed by connecting a plurality of cross-sections having a hexagonal-shaped hollow.

17. The wheel assembly structure of claim 1, wherein the tire is an airless tire.
